(19) United States
(12) Patent Application Publication
(10) Pub. No.: US 2023/0031653 A1
(43) Pub. Date: Feb. 2, 2023

(54) TILTING WHEELED VEHICLE

(71) Applicant: ARCIMOTO, INC., Eugene, OR (US)

(72) Inventors: Robert Mighell, Eugene, OR (US); David Wayne Boyd, Lake Oswego, OR (US)

(21) Appl. No.: 17/867,342

(22) Filed: Jul. 18, 2022

Related U.S. Application Data
(60) Provisional application No. 63/203,312, filed on Jul. 16, 2021.
(60) Provisional application No. 63/312,699, filed on Feb. 22, 2022.

(51) Int. Cl. B62K 5/10; B62K 21/12; B62K 5/05; B62M 6/60

(52) U.S. Cl. CPC B62K 5/10; B62K 21/12; B62K 5/05; B62M 6/60

(57) ABSTRACT

Features of a tilting wheeled vehicle are disclosed, including a steering system, a wheel system, and an intermediate pivot yoke that can couple the steering system to the wheel system.

### CROSS REFERENCE TO RELATED APPLICATIONS

This application claims priority to U.S. provisional application No. 63/312,699, filed Feb. 22, 2022 and to U.S. provisional application No. 63/203,312, filed Jul. 16, 2021, the entirety of these applications is hereby incorporated herein by reference for all purposes.

### BACKGROUND

Examples of tilting wheeled vehicles are described by U.S. Pat. No. 8,925,940, the entire contents of which is incorporated herein by reference for all purposes. At least some of these tilting wheeled vehicles are three-wheeled vehicles that feature a pair of front steerable wheels and a single rear wheel.

### SUMMARY

Features of a tilting wheeled vehicle are disclosed, including a steering system, a wheel system, and an intermediate pivot yoke that can couple the steering system to the wheel system.

According to an example, the steering system for the tilting wheeled vehicle comprises: a steering knuckle including: a bracket coupled to a steering shaft; and a central carrier coupled to the bracket by a first rotational bearing and by a second rotational bearing located on opposing sides of the central carrier. The central carrier is rotatable relative to the bracket about a first axis via the first rotational bearing and the second rotational bearing. The steering system further comprises a first tie rod coupled to a first side of the central carrier by a first spherical bearing; and a second tie rod coupled to a second side of the central carrier opposite the first side by a second spherical bearing. The first tie rod is rotatable in multiple degrees of freedom relative to the central carrier via the first spherical bearing. The second tie rod is rotatable in multiple degrees of freedom relative to the central carrier via the second spherical bearing. The first spherical bearing and the second spherical bearing are spaced apart from each other in a dimension that is orthogonal to the first axis.

### BRIEF DESCRIPTION OF THE DRAWINGS

FIG. 1 shows an example steering system that can be used with a tilting wheeled vehicle.

FIGS. 2 and 3 show an example wheel system that can be used with a tilting wheeled vehicle.

FIG. 4 shows an example pivot yoke that can be used to couple the steering system of FIG. 1 to the wheel system of FIGS. 2 and 3.

FIGS. 5A-5F show aspects of an example tiltable electric vehicle.

FIGS. 6A and 6B show an example wheel system having an alternative configuration from the wheel system of FIG. 2.

### DETAILED DESCRIPTION

Features of a tilting wheeled vehicle are disclosed, including a steering system, a wheel system, and an intermediate pivot yoke that can couple the steering system to the wheel system. The disclosed steering system, a wheel system, and pivot yoke can be used in a three-wheeled vehicle, such as disclosed by U.S. Pat. No. 8,925,940. However, the disclosed steering system, a wheel system, and pivot yoke can be used in a variety of other types of vehicles that have different form factors.

The tilting wheeled vehicles disclosed herein can feature electric hub motors in right and left wheels. The hub motors can each include an exterior portion and an interior portion that rotate relative to each other. The exterior and interior portions of the hub motor each include a different one of the rotor or the stator, and a different one of the armature windings or magnets. In one example, the wheel can be mounted upon the exterior portion of the hub motor, and an upper A-arm, a lower A-arm, and a tie rod for the steering system can be rotatably coupled to the interior portion of the hub motor. In another example, the wheel can be mounted upon the interior portion of the hub motor and the upper A-arm, the lower A-arm, and the tie rod for the steering system can be rotatably coupled to the exterior portion of the hub motor. In each of these examples, a steering axis of the wheel can be located within a central plane that bisects the wheel and within which the wheel rotates.

According to an example of the present disclosure, a steering system for a tilting wheeled vehicle comprises: a steering knuckle including: a bracket coupled to a steering shaft; and a central carrier coupled to the bracket by a first rotational bearing and by a second rotational bearing located on opposing sides of the central carrier. The central carrier is rotatable relative to the bracket about a first axis via the first rotational bearing and the second rotational bearing. The steering system further comprises a first tie rod (e.g., a left tie rod for a left wheel of the vehicle) coupled to a first side of the central carrier by a first spherical bearing; and a second tie rod (e.g., a right tie rod for a right wheel of the vehicle) coupled to a second side of the central carrier opposite the first side by a second spherical bearing. The first tie rod is rotatable in multiple degrees of freedom relative to the central carrier via the first spherical bearing. The second tie rod is rotatable in multiple degrees of freedom relative to the central carrier via the second spherical bearing. The first spherical bearing and the second spherical bearing are spaced apart from each other in a dimension that is orthogonal to the first axis.

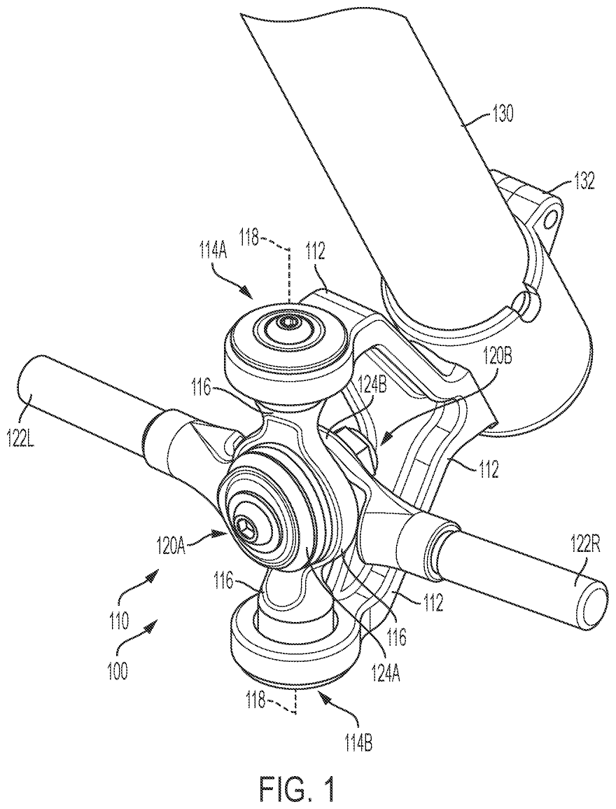

FIG. 1 shows a portion of a steering system 100 that includes an example steering knuckle 110. Steering knuckle 110 includes a bracket 112 that supports a first rotational bearing 114A and a second rotational bearing 114B that enables rotation of central carrier 116 about an axis 118. Steering knuckle 110 further includes a first spherical bearing 120A and a second spherical bearing 120B supported by central carrier 116. In this example, first spherical bearing 120A is located on a opposite side of central carrier 116 in a dimension that is orthogonal to axis 118. First spherical bearing 120A is coupled to a first tie rod 122L of steering system 100 by a collar 124A allowing a distal end of the first tie rod to pivot in multiple degrees of freedom relative to central carrier 116. Second spherical bearing 120B is coupled to a second tie rod 122R of steering system 100 by a collar 124B allowing a distal end of the second tie rod to pivot in multiple degrees of freedom relative to central carrier 116. Steering system 100 further includes a steering shaft 130 mounted to bracket 112 via a shaft clamp 132. A steering wheel or handlebar may be mounted to a distal end of steering shaft 130 enabling a human operator to provide a rotational control input to the steering shaft.

Steering knuckle 110 may have the potential to offer a range of motion that exceeds prior approaches. According to a prophetic example, steering knuckle 110 of steering system 100 allows for +/−45 degrees of tilt of a vehicle, +/−60 degrees of steering, and +/−25 degrees of suspension jounce. Steering knuckle 110 can maintain a constant geometrically centered pivot point for tie rod ends throughout the range of motion, allows independent suspension motion of each tie rod while maintaining a central pivot point, and allows for slight misalignment of tie rods to compensate for steering knuckle swing through the range of motion to prevent binding of tie rods.

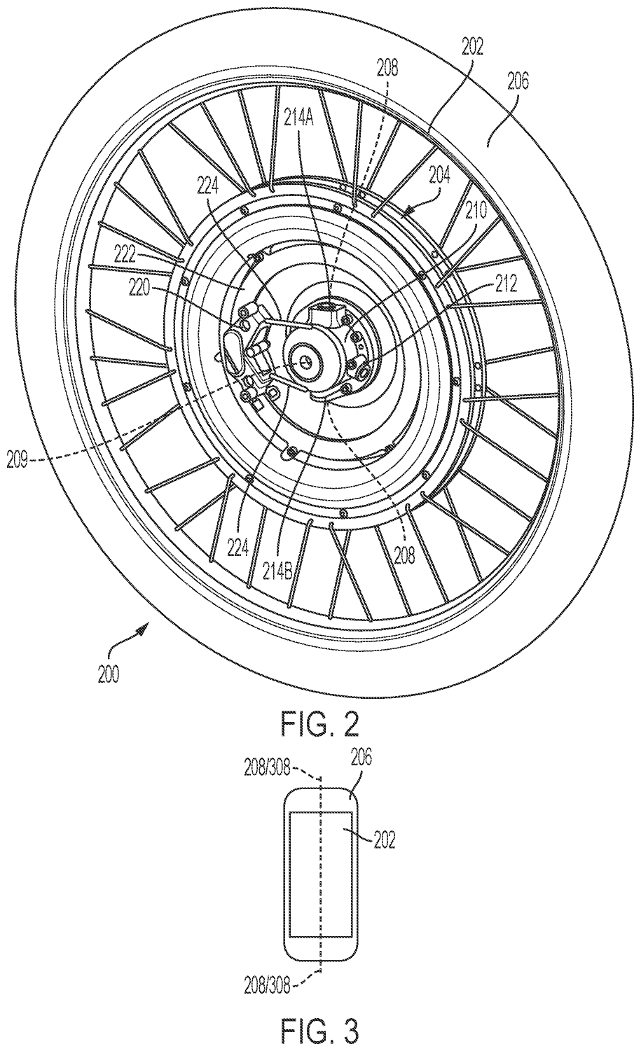

In at least some implementations, steering system 100 can be used in combination with left and right instances of wheel system 200 of FIG. 2. In this example, wheel system 200 includes a centrally mounted electric hub motor 204 having an interior portion and an exterior portion that rotates about the interior portion 204. A wheel is mounted upon the exterior portion. Wheel 202 is shown in FIG. 2 with an example tire 206.

The interior portion of hub motor 204 includes a hub body 210. First tie rod 122L or second tie rod 122R of steering system 100 can be coupled to a tie rod mount 212 provided on hub body 210. Hub body 210 further includes rotational steering mounts 214A and 214B that enable rotation of the wheel system relative to the vehicle about a steering axis 208 that is orthogonal to an axis of rotation 209 of the exterior portion of hub motor 204 and wheel 202. Steering axis 208 provided by rotational steering mounts 214A and 214B resides within a central plane 308 that bisects tire 206 and wheel 202 (e.g., at the outer rim of the wheel) when viewed along a path of travel of the wheel as shown schematically in FIG. 3.

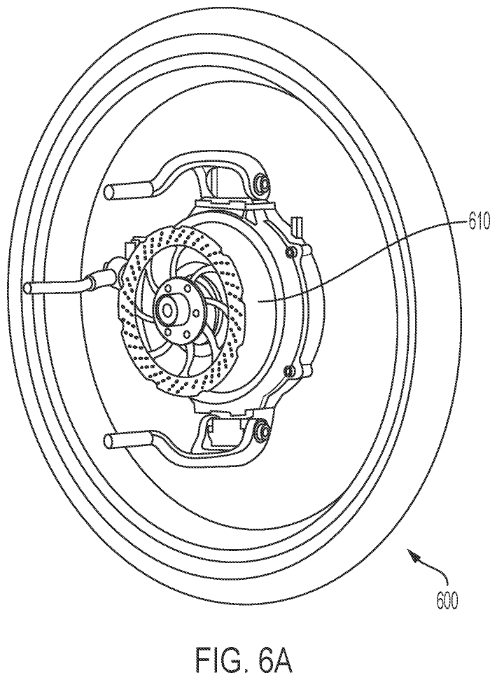

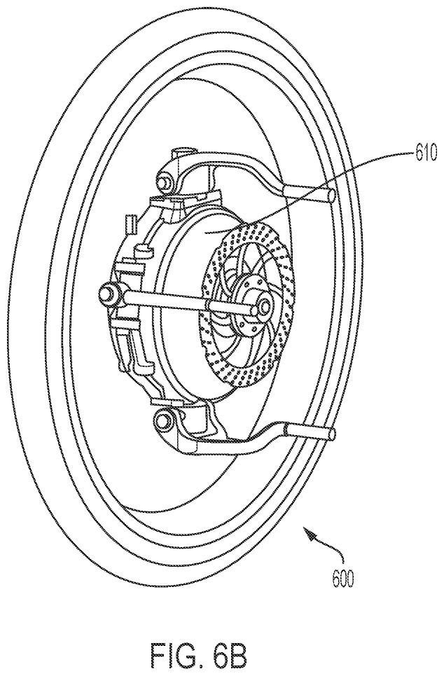

Wheel system 200 further includes a brake caliper 220 that is operative to engage a brake rotor 222 of the wheel system to provide braking. A body of brake caliper 220 can be mounted to the interior portion of hub motor 204 (e.g., hub body 210) by a bracket represented schematically in FIG. 2 by reference numeral 224. Brake rotor 222 can be mounted to the exterior portion of the hub motor 204. However, in alternative configurations, the brake rotor can be mounted to the interior portion of the hub motor, and the brake caliper can be mounted to the exterior portion of the hub motor, such as with the hub motor configuration of FIGS. 6A and 6B. Furthermore, in at least some examples, mechanical brakes may be omitted, such as where the hub motors provide regenerative braking.

According to a prophetic examples, alignment of steering axis 208 with central plane 308 enables +/−45 degrees of tilt of the wheel, allows +/−60 degrees of steering angle, allows an internally mounted disc brake rotor (e.g., 222) and caliper (e.g., 220), and allows a common motor design to be used on left and right wheel systems by using a separate steering tie rod pivot block to accommodate Ackermann geometry on both sides for proper steering motion.

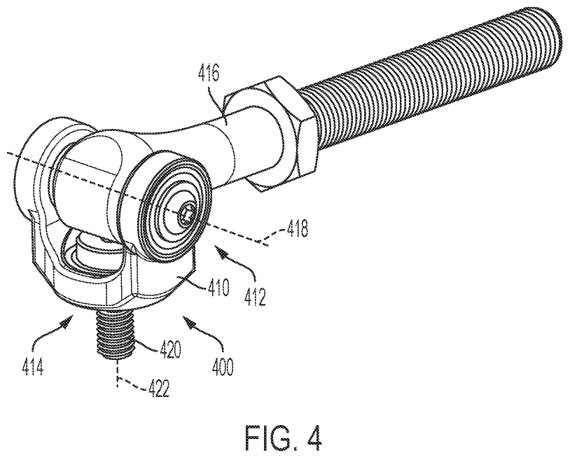

FIG. 4 shows an example pivot yoke 400 that can be used to couple first tie rod 122L or second tie rod 122R of steering system 100 to an instance of wheel system 200 via tie rod mount 212. Additional instances of pivot yoke 400 can be used to couple an upper A-arm and a lower A-arm to the hub body 210 via steering mounts 214A and 214B, respectively.

Pivot yoke 400 includes a yoke body 410 that supports a first rotational bearing 412 and a second rotational bearing 414. First rotational bearing 412 enables a first portion 416 of pivot yoke 400 to rotate relative to yoke body 410 about a first rotational axis 418. Second rotational bearing 414 enables a second portion 420 of pivot yoke 400 to rotate relative to yoke body 410 about a second rotational axis 422 that is orthogonal to the first rotational axis 418. However, in some examples, yoke body 410 is mounted to the wheel system via a fastener that does not permit rotation of the yoke body relative to the wheel system about second rotational axis 422.

In the example depicted in FIG. 4, first portion 416 includes a threaded shaft that can be coupled to tie rod 122L or 122R, or to an upper or lower A-arm via an intermediate connector or a distal end of the tie rod or A-arm can incorporate a connector (e.g., a threaded receptacle) that accommodates the threaded shaft at a distal end of portion 416. However, other suitable configurations may be used. Also in this example, wheel-side portion 420 includes a threaded shaft that can be coupled to mounts 212, 214A, or 214B (e.g., via a threaded receptacle of the mount). Again, it will be understood that other suitable configurations may be used.

According to a prophetic example, pivot yoke 400 can allow a full range of motion in both tilt and steering (two axes of motion) without the use of ball joints or rod ends for A-arms or tie rods. However, ball joints and rod ends can be used for A-arms and/or tie rods in other examples.

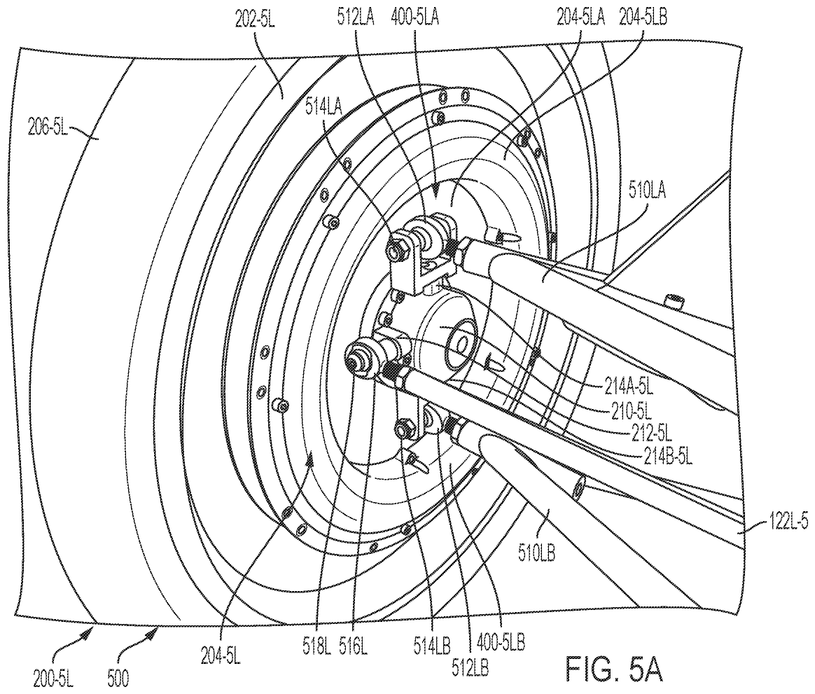

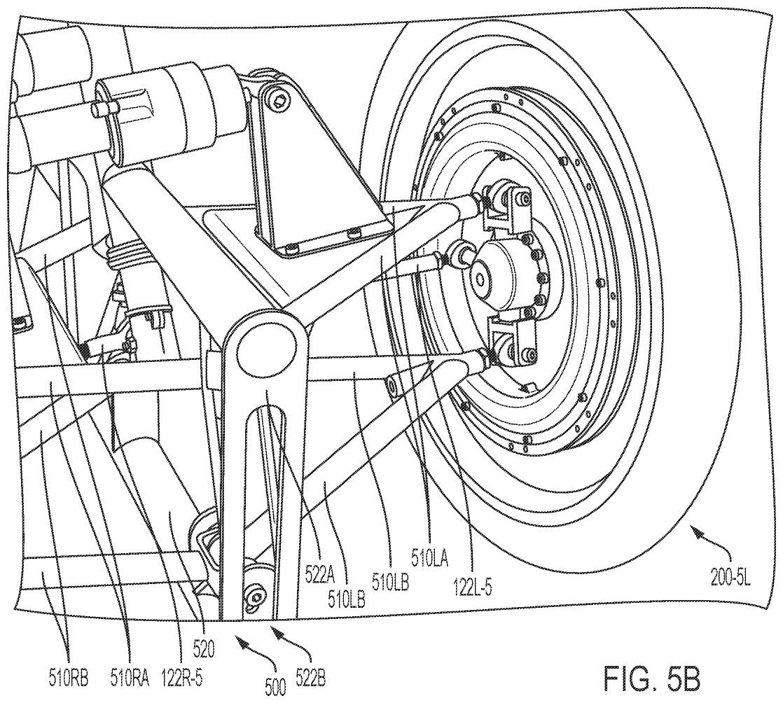

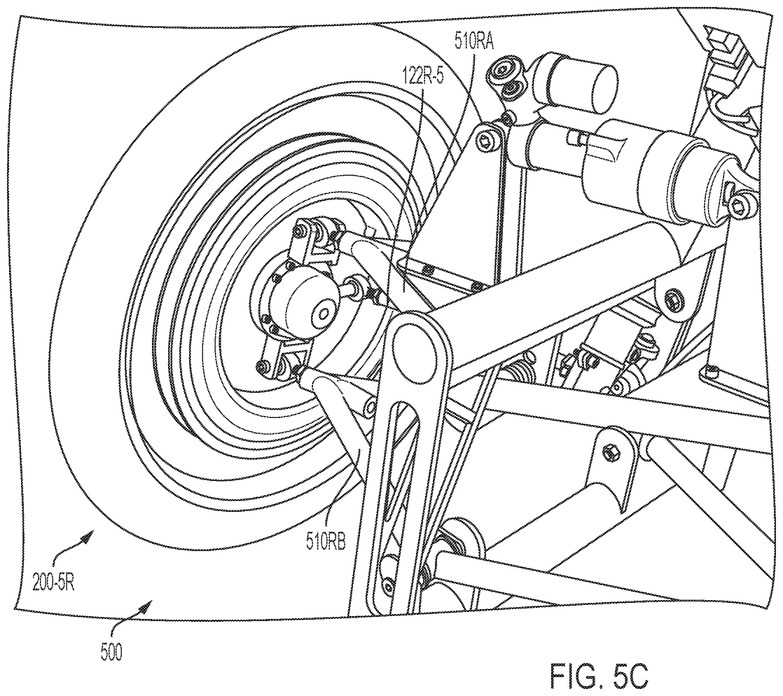

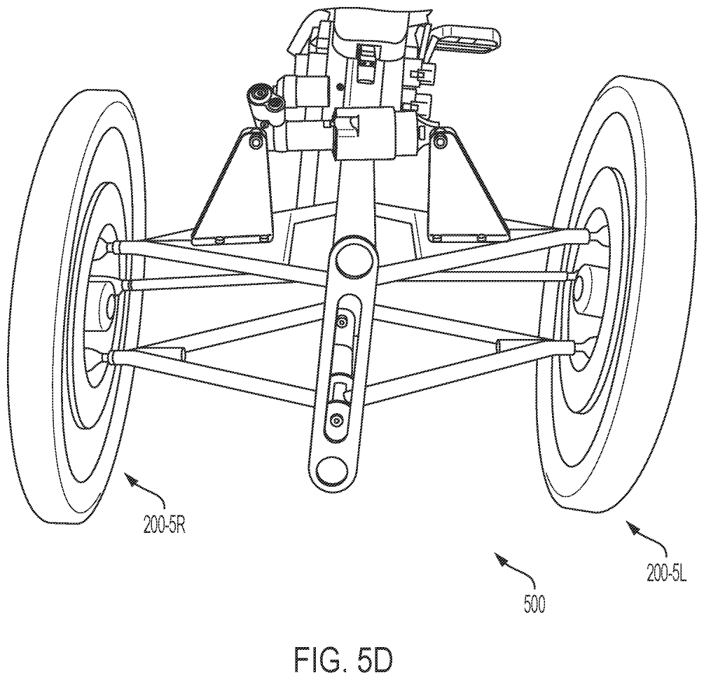

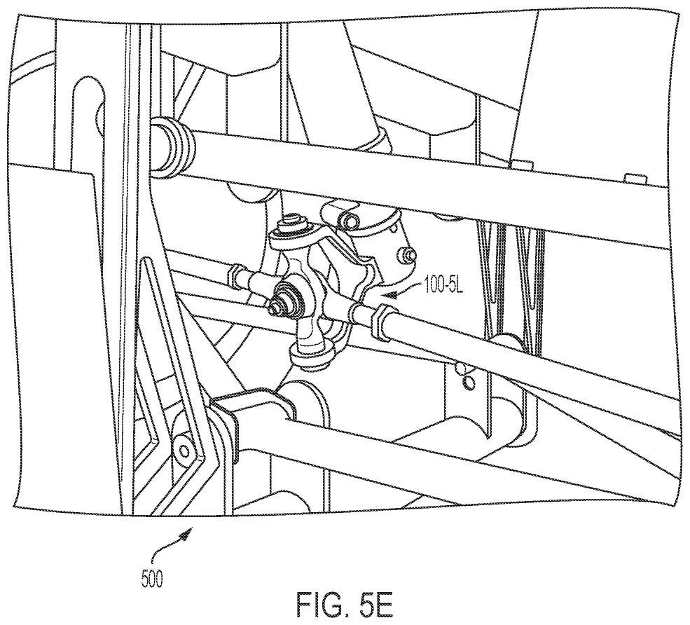

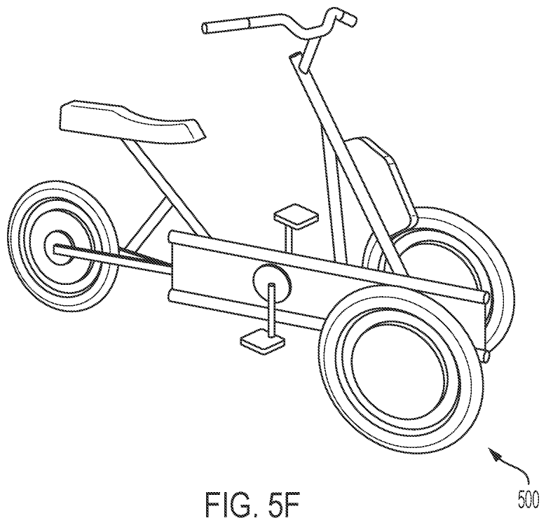

FIGS. 5A-5F show aspects of an example tiltable electric vehicle 500 that incorporates features previously described with reference to FIGS. 1-4.

FIG. 5A shows a rear interior side view of a wheel system 200-5L (as an example of wheel system 200 of FIG. 2) for a left wheel 202-5L of vehicle 500. Wheel system 200-5L includes an electric hub motor 204-5L that includes an interior portion 204-5LA and an exterior portion 204-5LB that rotates about interior portion 204-5LA. Left wheel 202-5L is mounted upon exterior portion 204-5LB. A tire 206-5L is mounted upon left wheel 202-5L in the example of FIG. 5A.

Hub body 210-5L of interior portion 204-5LA features tie rod mount 212-5L, an upper rotational steering mount 214A-5L, and a lower rotational steering mount 214B-5L. In this example, the armature windings and stator of hub motor 204-5L are on the outside of the central hub (e.g., at least partially or fully form a circular shape that surrounds the central hub about which the wheel rotates).

An upper pivot yoke 400-5LA (e.g., as an example instance of pivot yoke 400 of FIG. 4) is mounted to upper rotational steering mount 214A-5L (e.g., via an instance of 420), and a lower pivot yoke 400-5LB (e.g., as another example instance of pivot yoke 400 of FIG. 4) is mounted to lower rotational steering mount 214B-5L (e.g., via an instance of 420). A left upper A-arm 510LA (as an example instance of first portion 416) is rotatably coupled to upper pivot yoke 400-5LA to enable rotation about an instance of first rotational axis 418 (e.g., in a plane orthogonal to a path of travel of the vehicle). A left lower A-arm 510LB (as another example instance of first portion 416) is rotatably coupled to lower pivot yoke 400-5LB to enable rotation about another instance of first rotational axis 418 (e.g., in a plane orthogonal to a path of travel of the vehicle). In this example, upper A-arm 510LA includes an eye portion 512LA through which a ball joint of shaft 514LA passes that is carried by the yoke body of upper pivot yoke 400-5LA. Lower A-arm 510LB includes an eye portion 512LB through which a ball joint of shaft 514LB passes that is carried by the yoke body of lower pivot yoke 400-5LB. This configuration enables the A-arms to rotate relative to the wheel system in two orthogonal planes of rotation. It will be understood that the ball joints can be replaced by a shaft that provide rotation in a single plane in examples where the pivot yokes also supports rotation relative to the hub body about the steering axis, such as described with reference to FIG. 4.

A left tie rod 122L-5 (as an example of tie rod 122L) is rotatably coupled to tie rod mount 212-5L. In this example, tie rod 122L-5 includes an eye portion 516L that enables rotation and pivoting of the tie rod 122L5 about a ball joint 518L within two orthogonal planes of rotation. However, an instance of pivot yoke 400 can be alternatively used to couple the tie rod to the wheel system without using a ball joint.

In the configuration of FIG. 5A, a circular-shaped interface between interior portion 204-5LA and exterior portion 204-5LB of hub motor 204-5L surrounds tie rod mount 212-5L, upper rotational steering mount 214A-5L, lower rotational steering mount 214B-5L of hub body 210-5L when viewed along an axis of rotation of wheel 202-5L. This circular interface also surrounds the pivot yokes, and distal ends of upper A-arm 510LA, lower A-arm 510LB, and tie rod 122L-5 that are coupled to hub body 210-5L when viewed along an axis of rotation of wheel 202-5L.

FIG. 5B shows a front interior side view of wheel system 200-5L of FIG. 5A. Additionally, FIG. 5A shows a right tie rod 122R-5, a right upper A-arm 510RA, and a right lower A-arm 510RB for a right wheel system 200-5R shown in further detail in FIG. 5C. FIG. 5B also shows right lower A-arm 510RB and left lower A-arm 510LB rotatably coupled to frame 520 about a lower axis of rotation 522B. Right upper A-arm 510RA and left upper A-arm 510LA are also rotatably coupled to frame 520 about an upper axis of rotation 522A, shown in further detail in FIGS. 5C, 5D, and 5E.

FIG. 5C shows a front interior side view of wheel system 200-5R for a right wheel of vehicle 500. Wheel system 200-5R can include similar, symmetrical right-side components as those previously described with reference to left-side components of wheel system 200-5L.

FIG. 5D shows a front view of vehicle 500 depicting wheel system 200-5L, wheel system 200-5R, and a steering system 100-5 (as an example of steering system 100 of FIG. 1). Vehicle 500 is shown in FIG. 5D in a tilted position, as enabled by the steering and wheel system components disclosed herein.

FIG. 5E shows a rear view of steering system 100-5 showing steering knuckle 110-5 (as an example of steering knuckle 110 of FIG. 1).

FIG. 5F shows a right-side view of vehicle 500. In this example, vehicle 500 takes the form of a tiltable electric vehicle having two front wheels of wheel systems 200-5L and 200-5R, and a single rear wheel. Vehicle 500 include an on-board battery system for powering the electric hub motors. In at least some examples, vehicle 500 further includes a set of pedals that enables a human operator to charge the battery system via an electric generator. The electric hub motors of wheel systems 200-5L and 200-5R can also be used to provide regenerative braking that charges the battery system. Regenerative braking can replace or augment the use of brake calipers and associated brake rotors for the front wheels.

FIGS. 6A and 6B show an example wheel system 600 having an alternative configuration that can be used in place of wheel systems 200, 200-5L, and 200-5R. In this example, wheel system 600 includes an electric hub motor 610 that is disposed between upper and lower A-arm pivot yokes. For example, the A-arms and the tie rod can be rotatably coupled to the hub casing of hub motor 610 as similarly described with reference to wheel systems 200, 200-5L, and 200-5R. FIG. 6B further shows interior motor components of hub motor 610 that defines an interface between the interior and exterior portions of the hub motor. In this configuration, the wheel is mounted to the interior portion of the hub motor rather than the exterior portion of the hub motor. Similar to the example of FIG. 2, a steering axis provided by rotational steering mounts of wheel system 600 can reside within a central plane that bisects the wheel and tire when viewed along a path of travel of the wheel as shown schematically in FIG. 3.

In at least some examples a tiltable electric vehicle can incorporate at least some of the features previously described with reference to FIGS. 1-4, 5A-5 and FIGS. 6A and 6B. An example of this configuration is vehicle 700 of FIGS. 7A-7H of U.S. provisional application ser. No. 63/312,699, incorporated herein by reference. In contrast to vehicle 500, vehicle 700 uses the configuration of wheel system 600 in which the wheels are mounted to the interior portion of hub motor 610 that rotates relative to the exterior portion of the hub motor, and the upper and lower A-arms and tie rod for the steering system are rotatably coupled to the exterior portion of the hub motor. Similar to the example of FIG. 2, a steering axis provided by rotational steering mounts of wheel system 600 within the context of vehicle 700 can reside within a central plane that bisects the wheel and tire when viewed along a path of travel of the wheel as shown schematically in FIG. 3.

According to examples of the present disclosure, a tilting wheeled vehicle (i.e., a tiltable wheeled vehicle), comprises: a steering system including a steering shaft, a first tie rod, a second tie rod, and a steering knuckle that rotatably couples the first tie rod and the second tie rod to the steering shaft; a first wheel; a first hub motor including a first portion and a second portion rotatable relative to the first portion, the first wheel mounted to the second portion of the first hub motor, the first tie rod being rotatably coupled to the first portion of the first hub motor; a second wheel; and a second hub motor including a first portion and a second portion rotatable relative to the first portion, the second wheel mounted to the second portion of the second hub motor, the second tie rod being rotatably coupled to the first portion of the second hub motor. As an example, the steering knuckle includes: a bracket coupled to the steering shaft; and a central carrier coupled to the bracket by a first rotational bearing and by a second rotational bearing located on opposing sides of the central carrier, the central carrier being rotatable relative to the bracket about a first axis via the first rotational bearing and the second rotational bearing; wherein the first tie rod is coupled to a first side of the central carrier by a first spherical bearing, the first tie rod being rotatable in multiple degrees of freedom relative to the central carrier via the first spherical bearing; wherein the second tie rod is coupled to a second side of the central carrier opposite the first side by a second spherical bearing, the second tie rod being rotatable in multiple degrees of freedom relative to the central carrier via the second spherical bearing; wherein the first spherical bearing and the second spherical bearing are spaced apart from each other in a dimension that is orthogonal to the first axis. As an example, the tilting wheeled vehicle further comprises: a first upper A-arm and a first lower A-arm each rotatably coupled to the first portion of the first hub motor on opposing sides of a central rotational axis of the first hub motor; and a second upper A-arm and a second lower A-arm each rotatably coupled to the first portion of the second hub motor on opposing sides of a central rotational axis of the second hub motor; wherein the first upper A-arm and the second upper A-arm are rotatably coupled to a frame of the tilting wheeled vehicle about a second axis of rotation; wherein the first lower A-arm and the second lower A-arm are rotatably coupled to the frame of the tilting wheeled vehicle about a third axis of rotation. As an example, the first tie rod, the first upper A-arm, and the first lower A-arm are rotatably coupled to the first portion of the first hub motor at a central plane of the first wheel; and the second tie rod, the second upper A-arm, and the second lower A-arm are rotatably coupled to the first portion of the second hub motor at a central plane of the second wheel. As an example, the first portion of the first hub motor is an interior portion of the first hub motor and the second portion of the first hub motor is an exterior portion of the first hub motor; and the first portion of the second hub motor is an interior portion of the second hub motor and the second portion of the second hub motor is an exterior portion of the second hub motor. As an example, the first portion of the first hub motor is an exterior portion of the first hub motor and the second portion of the first hub motor is an interior portion of the first hub motor; and the first portion of the second hub motor is an exterior portion of the second hub motor and the second portion of the second hub motor is an interior portion of the second hub motor. As an example, the tilting wheeled vehicle further comprises a first pivot yoke that rotationally couples the first tie rod to the first portion of the first motor hub, wherein the first pivot yoke enables the first tie rod to rotate about two axes relative to the first portion of the first motor hub; and a second pivot yoke that rotationally couples the second tie rod to the first portion of the second motor hub, wherein the second pivot yoke enables the second tie rod to rotate about two axes relative to the first portion of the second motor hub. As an example, the first upper A-arm and the first lower A-arm are each rotatably coupled to the first portion of the first hub motor by respective pivot yokes that enable rotation in two axes; and the second upper A-arm and the second lower A-arm are each rotatably coupled to the first portion of the second hub motor by respective pivot yokes that enable rotation in two axes. As an example, the first hub motor and second hub motor are each an electric motor. As an example, the tilting wheeled vehicle takes the form of an electric tilting three-wheeled vehicle that further comprises a third wheel located along a central plane of the vehicle and the first wheel and second wheel are located on opposing sides of the central plane; and one or more batteries for powering the first hub motor and the second hub motor. As an example, the electric tilting three-wheeled vehicle, further comprises: an electric generator; and a set of pedals having crank arms coupled to the electric generator to generate electrical energy by human-powered input to the set of pedals; wherein the electrical energy generated via the electric generator recharges the one or more batteries and/or powers the first hub motor and the second hub motor. As an example, the electric tilting three-wheeled vehicle, further comprises: a third hub motor; and wherein the third wheel is mounted to the third hub motor; wherein the one or more batteries further power the third hub motor. As another example, the electrical energy generated via the electric generator powers the third hub motor.

It will be understood that the configurations and/or approaches described herein are exemplary in nature, and that these specific implementations or examples are not to be considered in a limiting sense, because numerous variations are possible. The subject matter of the present disclosure includes all novel and non-obvious combinations and sub-combinations of the various systems and configurations, and other features, functions, acts, and/or properties disclosed herein, as well as any and all equivalents thereof.

1. A steering system for a tilting wheeled vehicle, the steering system comprising:
a steering knuckle including:
a bracket coupled to a steering shaft; and
a central carrier coupled to the bracket by a first rotational bearing and by a second rotational bearing located on opposing sides of the central carrier, the central carrier being rotatable relative to the bracket about a first axis via the first rotational bearing and the second rotational bearing;
a first tie rod coupled to a first side of the central carrier by a first spherical bearing, the first tie rod being rotatable in multiple degrees of freedom relative to the central carrier via the first spherical bearing; and
a second tie rod coupled to a second side of the central carrier opposite the first side by a second spherical bearing, the second tie rod being rotatable in multiple degrees of freedom relative to the central carrier via the second spherical bearing.

2. The steering system of claim 1, wherein the first spherical bearing and the second spherical bearing are spaced apart from each other in a dimension that is orthogonal to the first axis.

3. A tilting wheeled vehicle, comprising:
a steering system including a steering shaft, a first tie rod, a second tie rod, and a steering knuckle that rotatably couples the first tie rod and the second tie rod to the steering shaft;
a first wheel;
a first hub motor including a first portion and a second portion rotatable relative to the first portion, the first wheel mounted to the second portion of the first hub motor, the first tie rod being rotatably coupled to the first portion of the first hub motor;
a second wheel; and
a second hub motor including a first portion and a second portion rotatable relative to the first portion, the second wheel mounted to the second portion of the second hub motor, the second tie rod being rotatably coupled to the first portion of the second hub motor.

4. The tilting wheeled vehicle of claim 3, wherein the steering knuckle includes:
a bracket coupled to the steering shaft; and
a central carrier coupled to the bracket by a first rotational bearing and by a second rotational bearing located on opposing sides of the central carrier, the central carrier being rotatable relative to the bracket about a first axis via the first rotational bearing and the second rotational bearing;
wherein the first tie rod is coupled to a first side of the central carrier by a first spherical bearing, the first tie rod being rotatable in multiple degrees of freedom relative to the central carrier via the first spherical bearing;
wherein the second tie rod is coupled to a second side of the central carrier opposite the first side by a second spherical bearing, the second tie rod being rotatable in multiple degrees of freedom relative to the central carrier via the second spherical bearing;
wherein the first spherical bearing and the second spherical bearing are spaced apart from each other in a dimension that is orthogonal to the first axis.

5. The tilting wheeled vehicle of claim 4, further comprising:
a first upper A-arm and a first lower A-arm each rotatably coupled to the first portion of the first hub motor on opposing sides of a central rotational axis of the first hub motor; and
a second upper A-arm and a second lower A-arm each rotatably coupled to the first portion of the second hub motor on opposing sides of a central rotational axis of the second hub motor;
wherein the first upper A-arm and the second upper A-arm are rotatably coupled to a frame of the tilting wheeled vehicle about a second axis of rotation;
wherein the first lower A-arm and the second lower A-arm are rotatably coupled to the frame of the tilting wheeled vehicle about a third axis of rotation.

6. The tilting wheeled vehicle of claim 5, wherein the first tie rod, the first upper A-arm, and the first lower A-arm are rotatably coupled to the first portion of the first hub motor at a central plane of the first wheel;
wherein the second tie rod, the second upper A-arm, and the second lower A-arm are rotatably coupled to the first portion of the second hub motor at a central plane of the second wheel.

7. The tilting wheeled vehicle of claim 3, wherein the first portion of the first hub motor is an interior portion of the first hub motor and the second portion of the first hub motor is an exterior portion of the first hub motor;
wherein the first portion of the second hub motor is an interior portion of the second hub motor and the second portion of the second hub motor is an exterior portion of the second hub motor.

8. The tilting wheeled vehicle of claim 3, wherein the first portion of the first hub motor is an exterior portion of the first hub motor and the second portion of the first hub motor is an interior portion of the first hub motor;
wherein the first portion of the second hub motor is an exterior portion of the second hub motor and the second portion of the second hub motor is an interior portion of the second hub motor.

9. The tilting wheeled vehicle of claim 3, wherein the first hub motor and second hub motor are each an electric motor.

10. The tilting wheeled vehicle of claim 3, further comprising a first pivot yoke that rotationally couples the first tie rod to the first portion of the first motor hub, wherein the first pivot yoke enables the first tie rod to rotate about two axes relative to the first portion of the first motor hub;
further comprising a second pivot yoke that rotationally couples the second tie rod to the first portion of the second motor hub, wherein the second pivot yoke enables the second tie rod to rotate about two axes relative to the first portion of the second motor hub.

11. The tilting wheeled vehicle of claim 3, wherein the first upper A-arm and the first lower A-arm are each rotatably coupled to the first portion of the first hub motor by respective pivot yokes that enable rotation in two axes;
wherein the second upper A-arm and the second lower A-arm are each rotatably coupled to the first portion of the second hub motor by respective pivot yokes that enable rotation in two axes.

12. An electric tilting three-wheeled vehicle, comprising:
a steering system including a steering shaft, a first tie rod, a second tie rod, and a steering knuckle that rotatably couples the first tie rod and the second tie rod to the steering shaft;
a first wheel;
a first hub motor including a first portion and a second portion rotatable relative to the first portion, the first wheel mounted to the second portion of the first hub motor, the first tie rod being rotatably coupled to the first portion of the first hub motor;
a second wheel;
a second hub motor including a first portion and a second portion rotatable relative to the first portion, the second wheel mounted to the second portion of the second hub motor, the second tie rod being rotatably coupled to the first portion of the second hub motor;
a third wheel located along a central plane of the vehicle; and
one or more batteries for powering the first hub motor and the second hub motor.

13. The electric tilting three-wheeled vehicle of claim 12, further comprising:
an electric generator;
a set of pedals having crank arms coupled to the electric generator to generate electrical energy by human-powered input to the set of pedals;
wherein the electrical energy generated via the electric generator recharges the one or more batteries and/or powers the first hub motor and the second hub motor.

14. The electric tilting three-wheeled vehicle of claim 13, further comprising a third hub motor; and where the third wheel is mounted to the third hub motor; and
wherein the electrical energy generated via the electric generator further powers the third hub motor.

15. The electric tilting three-wheeled vehicle of claim 13, further comprising a third hub motor; and where the third wheel is mounted to the third hub motor; and
wherein the one or more batteries further powers the third hub motor.
